(19) United States
(12) Patent Application Publication
(10) Pub. No.: US 2009/0067765 A1
(43) Pub. Date: Mar. 12, 2009

(54) Spindle motor having hydrodynamic bearing

(76) Inventor: Sang-Uk Kim, Seoul (KR)

Correspondence Address: Rober E Krebs;Thelen Reid Brown, Raysman & Steriner, P.O.Box 640640, San Jose, CA, 95164-0640, US

(21) Appl. No.: 11/919,814

(22) PCT Filed: May 2, 2006
(86) PCT No.: PCT/KR2006/001632

§ 371 Date: Nov. 2, 2007

(30) Foreign Application Priority Data
May 3, 2005 (KR) 10-2005-0037070

(51) Int. Cl. F16C 32/06

(52) U.S. Cl. 384/111

(57) ABSTRACT

Provided is a spindle motor having a hydrodynamic bearing with an improved structure to prevent oil leakage due to a centrifugal force generated when the motor is rotating. In the spindle motor, an oil gap is formed between a rotor and a fixing body to form the hydrodynamic bearing to rotate the rotor, and an oil groove is formed in a surface of the rotor or the fixing body, which faces the oil gap. Also, a taper seal is formed in an area that extends from the oil gap and contacts the air, between the rotor and the fixing body, and the rotor constituting the taper seal is placed of the rotation center of the fixing body. Thus, thus the amount of oil in the taper seal is minimized and oil leakage can be stably prevented.

### CROSS-REFERENCE TO RELATED PATENT APPLICATION OR PRIORITY CLAIM

This application is a national phase of International Application No. PCT/KR2006/001632 entitled “Spindle Motor Having Hydrodynamic Bearing”, which was filed on May 2, 2006, which was published in English, and which claims priority of the Korean Patent Application No. 10-2005-0037070 filed May 3, 2005.

### FIELD OF THE INVENTION

The present invention relates to a spindle motor having a hydrodynamic bearing, and more particularly, to a spindle motor having a hydrodynamic bearing with an improved structure to effectively prevent oil leakage due to a centrifugal force.

### BACKGROUND OF THE INVENTION

A conventional spindle motor has a hydrodynamic bearing in order to rotate a recording disk, and the hydrodynamic bearing uses fluid pressure of a lubricant inserted between a shaft and a sleeve to rotate and support the shaft and the sleeve.

FIG. 1 illustrates a conventional spindle motor which is disclosed in U.S. Pat. No. 6,456,458 and comprises: an inner sleeve 1 having a center hole; a shaft 4 inserted coaxially into the center hole such that a fine gap is formed between an outer circumferential surface of the shaft 4 and the center hole; an outer sleeve 2 that fixes the inner sleeve 1 and is fixed and coupled to a base 3; a stator 7 fixed to the external sleeve 2; a rotor hub 5 to which the shaft 4 is coupled to rotate together and which extends downward in a radial direction, wherein a magnet 8 facing the stator 7 is fixed on the extended inner surface and a fine gap extending in an axis direction between the ends of the sleeve 1 is formed to form a thrust bearing 9; a radial hydrodynamic bearing 10 formed in the center hole and on the outer circumferential surface; a taper seal 11 that is adjacent to the fine gap of the thrust hydrodynamic bearing 8 and prevents lubricant oil leakage; and a ring member 6 that is coupled to a lower end portion of the shaft 4 and prevents the hub 5 from being separated therefrom.

However, in the above-described spindle motor, the taper seal 11 is formed between a cylindrical wall 5a of the hub 5 that extends downward and the circumferential surface of the inner sleeve 1. Accordingly, when the hub 5 rotates, a large centrifugal force is generated, which makes the lubricant oil in the taper seal 11 flow at high speed along the cylindrical wall 5a, thereby creating oil leakage.

In other words, as a rotation unit (the cylindrical wall 5a) surrounds a fixing unit (the sleeve 1), the lubricant oil may escape from the taper seal 11 when the motor is working.

FIGS. 2 and 3 illustrate a spindle motor disclosed in Japanese Patent Laid-Open Gazette No. 2003-262217, in which a rotation unit 20 is disposed on the outside and a fixing unit (sleeve 22) is formed inside a taper seal 2l. In this structure, however, a large centrifugal force might separate the lubricant oil from the taper seal 21 while the motor is operating.

### SUMMARY OF THE INVENTION

The present invention provides a spindle motor having a hydrodynamic bearing with an improved structure to maintain uniform oil pressure between upper and lower bearings, which is caused by bubbles generated when the motor is working, and thereby prevent oil leakage.

The present invention also provides a spindle motor having a hydrodynamic bearing which can effectively prevent oil leakage when the motor is working or stops working.

The present invention also provides a spindle motor having a hydrodynamic bearing, in which a shaft is prevented from separating from the motor when the motor is working or being transported.

According to an aspect of the present invention, there is provided a spindle motor having a hydrodynamic bearing, and in which an oil gap is formed between a rotor and a fixing body to form a hydrodynamic journal bearing so as to rotatably support the rotor, and an oil groove is formed in a surface of the rotor or the fixing body facing the oil gap, the hydrodynamic bearing comprising: a taper seal that is formed between the rotor and the fixing body in an area that is extended from the oil gap and contacts the air, wherein the rotor is placed in the rotation center of the fixing body, and the taper seal is formed in an inner space between the upper end and the lower end of the section of the hydrodynamic journal bearing.

The fixing body may include: a base in which a center hole is formed in a center portion, a ring-shaped boss protrudes upward at the edge of the hole, and a stator is fixed; a sleeve that is coupled to the hole of the base and has a hollow shape; and a ring-shaped body that is coupled to the upper end of the ring-shaped boss or the sleeve to form a ring-shaped space between the ring-shaped body and the outer circumferential surface of the sleeve, and the rotor may include: a shaft that is rotatably coupled to the hole of the sleeve; and a hub in which an upper end of the shaft is coupled and fixed to the center portion of the hub, and an inner cylindrical wall body that extends in the lower surface of the hub to enter the ring-shaped space to form the first taper seal between the inner cylindrical wall body and the ring-shaped body is formed, the hydrodynamic bearing comprising: a thrust bearing formed by oil disposed between the low end surface of the inner cylindrical wall body and the sleeve; and upper/lower journal bearings formed by oil disposed between the shaft and the sleeve.

The ring-shaped body may be extended from and formed as a single unit with the ring-shaped boss or the sleeve.

A first connection hole may be formed linearly through the sleeve to connect the oil gap of the journal bearings and the oil gap of the thrust bearing.

Second and third taper seals connected with the first connection hole may be formed in the upper portion of the lower journal bearing and in the lower portion of the upper journal bearing, and a fourth taper seal may be formed in the upper end portion of the upper journal bearing and contacts the bottom surface of the hub.

The fixing body may include: a base in which a center hole is formed in a center portion, a ring-shaped boss protrudes upward at the edge from the hole, and a stator is fixed; a sleeve, which is coupled and fixed to the hole of the base and has a hollow shape, in which a separation prevention threshold is formed in the inner circumference of the lower end portion; and a ring-shaped body that is coupled to the upper end of the ring-shaped boss or the sleeve to form a ring-shaped space between the ring-shaped body and the outer circumferential surface of the sleeve, and the rotor may include: a shaft that is rotatably coupled to the hole of the sleeve; a hub in which an upper end of the shaft is coupled and fixed in the center portion and an inner cylindrical wall body that extends in the lower surface thereof to enter the ring-shaped space to form the taper seal between the inner cylindrical wall body and the ring-shaped body is formed, and a magnet that faces the stator is fixed in an inner space of the outer cylindrical wall body, extending downward from the edge of the hub; and a separation prevention ring that is coupled and fixed to the lower end of the shaft to be suspended from the separation prevention, and the hydrodynamic bearing comprising: a thrust bearing formed by oil disposed between the low end surface of the inner cylindrical wall body and the sleeve; and journal bearings formed by oil disposed between the shaft and the sleeve.

A second connection hole may be formed linearly through the sleeve to connect the oil gap of the journal bearings and the oil gap of the thrust bearing.

The sleeve may include a first sleeve rotatably supporting the shaft and a second sleeve to which the first sleeve is coupled and fixed and the ring-shaped body is extended from an upper end of the sleeve.

The hub may include a first hub having a center hole in which the shaft is coupled and fixed and the inner cylindrical wall body and a second hub having a hole in which the first hub is coupled and fixed and an outer cylindrical wall body to which the magnet is attached.

According to the present invention, the taper seal prevents oil leakage due to a capillary phenomenon that takes place between the fixing body and the rotor, since the rotor is located in the inner side of the fixing body (in the rotation center of the fixing body). Thus the amount of the oil in the taper seal is minimized and oil leakage is stably prevented

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic view of a conventional spindle motor;

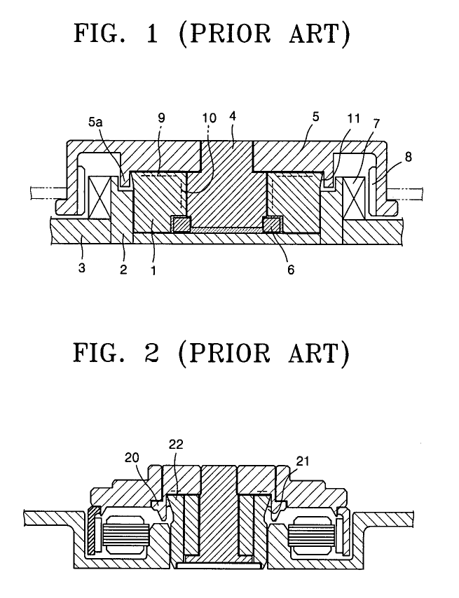

FIGS. 2 and 3 are cross-sectional views of another conventional spindle motor;

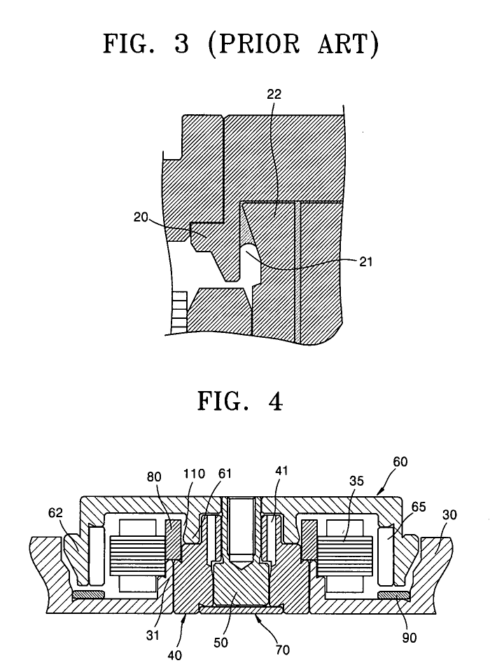

FIG. 4 is a cross-sectional view of a spindle motor according to an embodiment of the present invention;

FIG. 5 is an extended view of main portions of the spindle motor of FIG. 4;

FIG. 6 is a disassembled view of the spindle motor of FIG. 4;

FIG. 7 is a schematic view illustrating an oil groove constituting a journal bearing in the spindle motor of FIG. 4;

FIG. 8 is a schematic view illustrating an oil groove constituting a thrust bearing in the spindle motor of FIG. 4; and

FIGS. 9 through 14 are cross-sectional views of a spindle motor according to other embodiments of the present invention.

### DETAILED DESCRIPTION OF THE INVENTION

The present invention will now be described more fully with reference to the accompanying drawings, in which exemplary embodiments of the invention are shown.

A spindle motor is used for rotating a recording disk, for example, a hard disk, and employs a hydrodynamic bearing particularly for high precision rotation.

In a hydrodynamic bearing, an oil gap to be filled with oil is formed between a rotor and a fixing body so as to accurately support the rotor by hydrodynamic pressure.

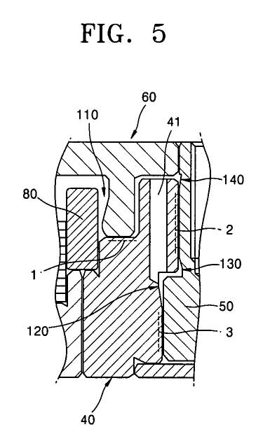

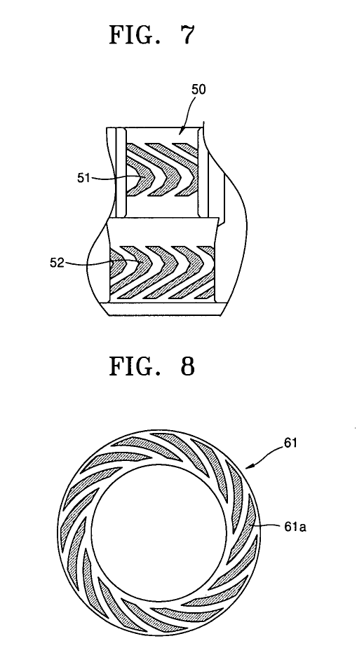

FIGS. 4 through 6 illustrate a spindle motor according to an embodiment of the present invention. Referring to FIGS. 4 and 6, an oil gap is formed between a rotor and a fixing body in order to form a hydrodynamic journal bearing to rotatably support the rotor, and an oil groove is formed in a surface of the rotor or the fixing body facing the oil gap.

A first taper seal 110 is formed between the rotor and the fixing body in an area that is extended from the oil gap and exposed to the air, and the rotor constituting the first taper seal 110 is disposed in a center portion of the fixing body.

Since the first taper seal 110 is formed in an inner space between upper and lower portions of the section of the journal bearing, the motor can be minimized.

The fixing body includes a base 30 in which a center hole formed in a center portion, a ring-shaped boss 31 protrudes toward the edge of the center hole, and a stator 35 is fixed; a hollow sleeve 40 that is coupled to the center hole and includes an upper portion of a small diameter portion 40a and a lower portion of a large diameter portion 40b; and a ring-shaped body 80 that is coupled to the ring-shaped boss 31 or the upper end of the sleeve 40, thereby forming a ring-shaped space 55 between the ring-shaped body 80 and an outer circumferential surface of the small diameter portion 40a of the sleeve 40.

The rotor includes: a shaft 50 having a small diameter portion 50a and a large diameter portion 50b, which are respectively rotatably coupled to the small/large diameter portions 40a and 40b of the sleeve 40; and a hub 60 in which an upper end of the shaft 50 is coupled and fixed in its center portion, and an inner cylindrical wall body 61 that is extended so as to intrude the ring-shaped space 55 is formed on the bottom surface so as to form the first taper seal 110 in the space between the inner cylindrical wall body 61 and the ring-shaped body 80, and a magnet 65 facing the stator 35 is fixed inside of an outer cylindrical wall body 62 that is extended downward from the margin of the outer cylindrical wall body 62.

Because of the small/large diameter portions of the sleeve 40 and the shaft 50, the shaft 50 is prevented from separating from the sleeve 40 in the upper direction.

A lower cover 70 that is coupled with the lower end portion of the sleeve 40 prevents the shaft 50 from separating from the sleeve 40 in the downward direction.

Oil is disposed between the lower end surface of the inner cylindrical wall body 61 and the sleeve 40 to form a thrust bearing 1, and between the shaft 50 and the sleeve 40 to form upper/lower journal bearings 2 and 3.

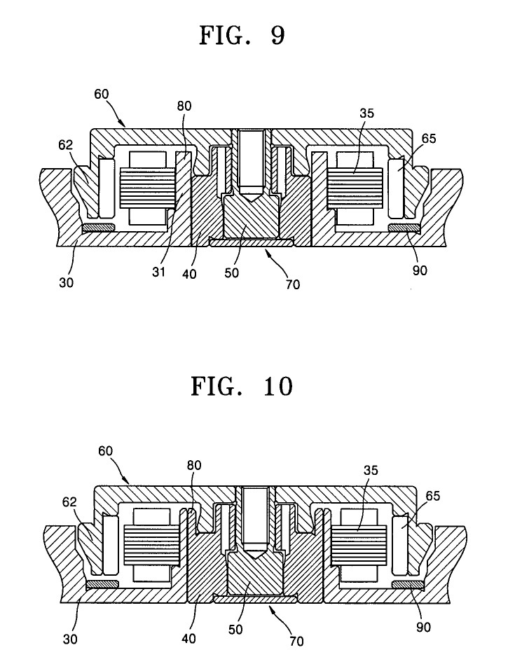

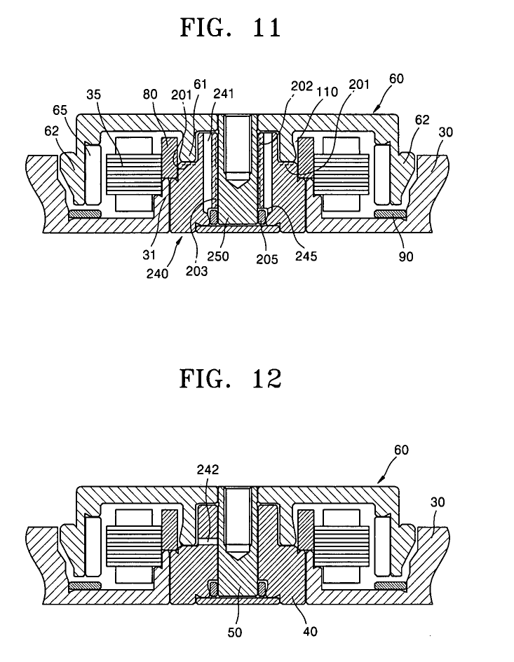

As illustrated in FIG. 8, an oil groove 61a having an inward spiral shape is formed in a lower end surface of the inner cylindrical wall body 61, and as illustrated in FIG. 7, oil grooves 51 and 52 are formed in an outer circumferential surface of the small/large diameter portions 50a and 50b of the shaft 50 in a herring bone shape.

The oil grooves 51, 52, and 61a may be formed in the sleeve 40. An inclined surface is formed in the inner cylindrical wall body 61 such that the first taper seal 110 extends upwardly and contacts the air. The inclined surface can be formed in the inner surface of the ring-shaped body 80.

The first taper seal 110 balances the surface tension of the oil and the atmospheric pressure, and the inner pressure of the oil in the taper seal 110 and the atmospheric pressure are substantially the same. Also, a first connection hole 41 passing through the sleeve 40 is formed to linearly connect the oil gap of the journal bearings 2 and 3 and the oil gap of the thrust bearing 1. In the current embodiment, the first connection hole 41 connects the space from the oil gap between the upper/lower journal bearings 2 and 3 and the space between the upper end of the sleeve 40 and the hub 60 linearly. Thus, the first connection hole 41 enables the pressure balance between the thrust bearing 1 and the journal bearings 2 and 3.

Moreover, as the oil groove 61a of the thrust bearing 1 is formed in an inward spiral shape, the inner pressure of the thrust bearing 1 is increased, and the increased pressure increases the pressure of oil in the journal bearings 2 and 3 through the first connection hole 41. Also, bubbles collected between the upper/lower journal bearings 2 and 3 pass through the first connection hole 41 and can be discharged in the air through the thrust bearing 1, and negative pressure between the upper/lower journal bearings 2 and 3 is suppressed.

Meanwhile, referring to FIGS. 4 through 6, a magnetic body 90 is formed on the bottom surface of the base 30 facing the magnet 65, and thus an attraction force is generated between the rotor and the fixing body. Accordingly, when the hub 60 rotates, the hub 60 is prevented from moving upward, thereby enabling the disk (not shown) to rotate highly precisely.

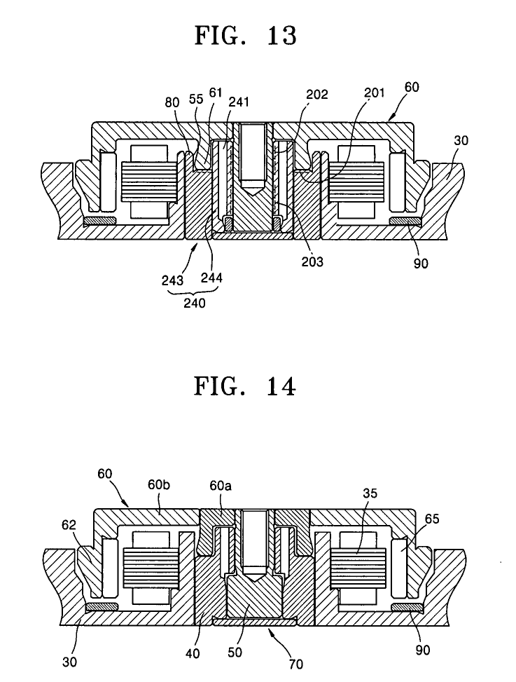

FIG. 9 illustrates a spindle motor according to another embodiment of the present invention. Referring to FIG. 9, the spindle motor includes a ring-shaped body 80 that is extended from and formed as a single unit with the ring-shaped boss 31 of the base 30. Accordingly, the ring-shaped body 80 need not be manufactured additionally, thereby reducing the number of components and assembling processes. Since the other components in the present embodiment are the same with the components of the spindle motor of FIG. 4 and illustrated with the same reference numerals, a description thereof will be omitted.

FIG. 10 illustrates a spindle motor according to another embodiment of the present invention. Referring to FIG. 10, the ring-shaped body 80 of FIG. 4 is extended from and formed as a single unit with the sleeve 40. Accordingly, the ring-shaped body 80 need not be manufactured additionally, thereby reducing the number of components and assembling processes. Since the other components in the present embodiment are the same with the components of the spindle motor of FIG. 4 and illustrated with the same reference numerals, a description thereof will be omitted.

FIG. 11 illustrates a spindle motor according to another embodiment of the present invention. Referring to FIG. 11, the same components as in FIG. 4 have the same reference numerals, and an oil gap is formed between the rotor and the fixing body to form a hydrodynamic bearing so as to rotatably support the rotor, and an oil groove is formed in a surface of the rotor or the fixing body facing the oil gap. A first taper seal 110 is further formed between the rotor and the fixing body in a space that is extended from the oil gap and exposed to the air, and the rotor constituting the first taper seal 110 is placed in the center portion of the fixing body.

The fixing body includes: a base 30 in which a center hole is formed in a center portion, a ring-shaped boss 31 protrudes upward at the edge of the center hole, and a stator 35 is fixed; a hollow sleeve 240, which is coupled to the center hole of the base 30 and has a hollow shape, in which a separation prevention threshold 245 is formed in the inner circumference of the lower end portion of the hollow hole; and a ring-shaped body 80 that is coupled to the upper end of the ring-shaped boss 31 or the sleeve 240 to form a ring-shaped space 55 between the ring-shaped body 80 and the outer circumferential surface of the sleeve 240.

Also, the rotor includes: a shaft 250 that is rotatably coupled to the hole of the sleeve 240; a hub 60 in which an upper end of the shaft 250 is coupled and fixed in a center portion, and an inner cylindrical wall body 61 is extended in the lower surface of the hub 60 to intrude the ring-shaped space 55 (see FIG. 6) to form the first taper seal 110 between the inner cylindrical wall body 61 and the ring-shaped body 80, and a magnet 65 facing the stator 35 is fixed in an inner space extended downwardly from the edge thereof; and a separation prevention ring 205 that is coupled and fixed to the lower end of the shaft 250 to be suspended from the separation prevention 245.

Oil is dispo SPINDLE MOTOR HAVING HYDRODYNAMIC BEARING sed between the lower end surface of the inner cylindrical wall body 61 and the sleeve 240 to form a thrust bearing 201, and between the shaft 250 and the sleeve 240 to form journal bearings 202 and 203.

As illustrated in FIG. 8, an oil groove 61a having an inward spiral shape is formed in a lower end surface of the inner cylindrical wall body 61, and as illustrated in FIG. 7, oil grooves 51 and 52 having a herring bone shape are formed on the outer circumferential surface of the shaft 250.

In the embodiment of FIG. 11, a separation prevention threshold 245 is formed in the lower end portion of the sleeve 240 to prevent the shaft 250 from separating upward using the separation prevention ring 205, which is inserted into the lower end portion of the shaft 250.

Thus, the sleeve 240 and the shaft 250 can be efficiently made. The ring-shaped body 80 can, as illustrated in FIG. 13, be extended from and formed as a single unit with the sleeve 240.

Referring to FIG. 13, the sleeve 240 includes a first sleeve 244 rotatably supporting the shaft 250 and a second sleeve 243 to which the first sleeve 244 is fixed and coupled and in which the ring-shaped body 80 is extended at the upper edge of the second sleeve 243.

In the present embodiment, the sleeve 240 can be separately manufactured, thus creating the ring-shaped space 55 easily.

Meanwhile, referring to FIGS. 11 and 13, a second connection hole 241 passing through the sleeve 240 is formed to linearly connect the oil gap of the journal bearings 202 and 203 and the oil gap of the thrust bearing 201.

The second connection hole 241 enables the pressure balance between the thrust bearing 201 and the journal bearings 202 and 203.

Furthermore, as the oil groove 61a of the thrust bearing 201 is formed to have an inward spiral shape, the inner pressure of the thrust bearing 201 is increased, and the increased pressure increases the oil pressure in the journal bearings 202 and 203 through the second connection hole 241. Also, the bubbles collected between the upper/lower journal bearings 202 and 203 pass through the second connection hole 241 and can be discharged through the thrust bearing 201 in the air, and negative pressure generated between the upper/lower journal bearings 202 and 203 is suppressed. In the present embodiment, the second connection hole 242, as illustrated in FIG. 12, can be formed through the sleeve 240 to be connected with the thrust bearing 201 and the space between the upper/lower journal bearings 202 and 203. Thus, the pressure balance of each of the bearings 201, 202, and 203 is achieved stably and bubbles and negative pressure can be effectively suppressed.

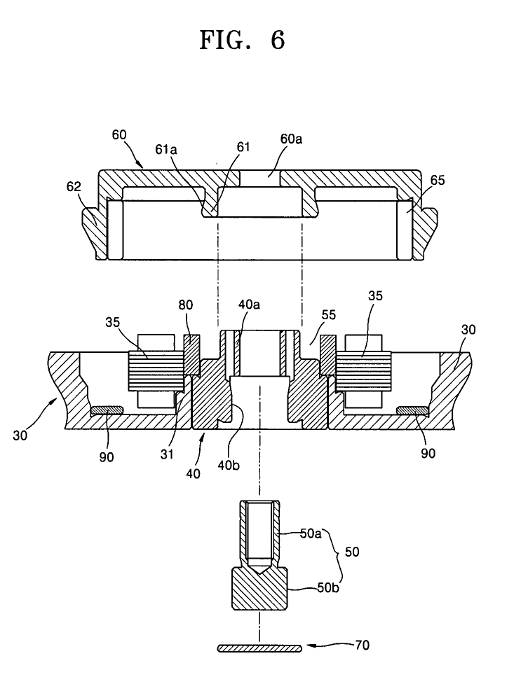

FIG. 14 illustrates a spindle motor according to another embodiment of the present invention. Referring to FIG. 14, the hub 60 is separated into a first hub 60a including a center hole to which the shaft 50 is coupled and fixed and the inner cylindrical wall body 61; and a second hub 60b including a hole to which the first hub 60a is coupled and fixed and an outer cylindrical wall body 62 to which a magnet 65 is attached, thereby facilitating oil injection into the oil gap. Meanwhile, in the embodiments of the present invention, a plurality of taper seals are formed in the upper/lower journal bearings 1, 201, 2, 3, 202, and 203 to prevent oil leakage. Referring to FIG. 5, second and third taper seals 120 and 130 connected with the first connection hole 41 are formed in the upper portion of the lower journal bearing 3 and in the lower portion of the upper journal bearing 2, and a fourth taper seal 140 is formed in the upper end portion of the upper journal bearing 2 contacting the lower surface of the hub 60.

As described above, in the present invention, oil leakage from the first taper seal 110 that contacts the air can be effectively prevented while the rotor rotates with respect to the fixing body, since the rotor is located in the rotation center of the fixing body.

While the present invention has been particularly shown and described with reference to exemplary embodiments thereof, it will be understood by those of ordinary skill in the art that various changes in form and details may be made therein without departing from the spirit and scope of the present invention as defined by the following claims.

As described above, the present invention has the following advantages.

First, in the present invention, the taper seal prevents oil leakage due to a capillary phenomenon that takes place between the fixing body and the rotor, since the rotor is located in the inner side of the fixing body (in the rotation center of the fixing body). Thus the amount of the oil in the taper seal is minimized and oil leakage is stably prevented.

Second, since a connection hole is formed to pass through the sleeve to connect the section between the oil gap of the journal bearing and the oil gap of the thrust bearing, the pressure balance between the thrust bearing and the journal bearing is achieved, and oil bubbles and negativ SPINDLE MOTOR HAVING HYDRODYNAMIC BEARING e pressure are suppressed. Thus, the motor can operate efficiently.

Also, since the oil groove of the thrust bearing is formed in an inward spiral shape, the inner pressure in the thrust bearing is increased, and the increased pressure which increases the pressure SPINDLE MOTOR HAVING HYDRODYNAMIC BEARING in the journal bearing through the connection hole, and thus conical vibrations of the thrust bearing can be prevented.

Third, the sleeve and the shaft having small/large diameter portions corresponding to each other or a separation prevention ring are employed to prevent the shaft from being being separated separated when the motor is operating or being transported driving or the transportation of the motor.

Fourth, a taper seal is formed in the section of the journal bearing, thus enabling reduction of the size of the motor.

What is claimed is:

1. A spindle motor having a hydrodynamic bearing, and in which an oil gap is formed between a rotor and a fixing body to form a hydrodynamic journal bearing so as to rotatably support the rotor, and an oil groove is formed in a surface of the rotor the fixing body facing the oil gap, the hydrodynamic bearing comprising:
a taper seal that is formed between the rotor and the fixing body in an area that is extended from the oil gap and contacts the air,
wherein the rotor is placed in the rotation center of the fixing body, and the taper seal is formed in an inner space between the upper end and the lower end of the section of the hydrodynamic journal bearing.

2. The spindle motor of claim 1, wherein the fixing body includes:
a base in which a center hole is formed in a center portion, a ring-shaped boss protrudes upward at the edge of the hole, and a stator is fixed;
a sleeve that is coupled to the hole of the base and has a hollow shape; and
a ring-shaped body that is coupled to the upper end of the ring-shaped boss or the sleeve to form a ring-shaped space between the ring-shaped body and the outer circumferential surface of the sleeve, and
the rotor includes:
a shaft that is rotatably coupled to the hole of the sleeve; and
a hub in which an upper end of the shaft is coupled and fixed to the center portion of the hub, and an inner cylindrical wall body that extends in the lower surface of the hub to enter the ring-shaped space to form the first taper seal between the inner cylindrical wall body and the ring-shaped body is formed,
the hydrodynamic bearing comprising:
a thrust bearing formed by oil disposed between the low end surface of the inner cylindrical wall body and the sleeve; and
upper/lower journal bearings and formed by oil disposed between the shaft and the sleeve.

3. The spindle motor of claim 2, wherein the ring-shaped body is extended from and formed as a single unit with the ring-shaped boss.

4. The spindle motor of claim 2, wherein the ring-shaped body is extended from and formed as a single unit with the sleeve.

5. The spindle motor employing a hydrodynamic bearing of claim 2, wherein a first connection hole is formed linearly through the sleeve to connect the oil gap of the journal bearings and the oil gap of the thrust bearing.

6. The spindle motor of claim 1, wherein the fixing body includes:
a base in which a center hole is formed in a center portion, a ring-shaped boss protrudes upward at the edge from the hole, and a stator is fixed;
a sleeve, which is coupled and fixed to the hole of the base and has a hollow shape, in which a separation prevention threshold is formed in the inner circumference of the lower end portion of the hollow hole; and
a ring-shaped body that is coupled to the upper end of the ring-shaped boss or the sleeve to form a ring-shaped space between the ring-shaped body and the outer circumferential surface of the sleeve, and
the rotor includes:
a shaft that is rotatably coupled to the hole of the sleeve;
a hub in which an upper end of the shaft is coupled and fixed in the center portion and an inner cylindrical wall body that extends in the lower surface thereof to enter the ring-shaped space to form the taper seal between the inner cylindrical wall body and the ring-shaped body is formed, and a magnet that faces the stator is fixed in an inner space of the outer cylindrical wall body, extending downward from the edge of the hub; and
a separation prevention ring that is coupled and fixed to the lower end of the shaft to be suspended from the separation prevention, and
the hydrodynamic bearing comprising:
a thrust bearing formed by oil disposed between the low end surface of the inner cylindrical wall body and the sleeve; and
journal bearings formed by oil disposed between the shaft and the sleeve.

7. The spindle motor of claim 6, wherein the ring-shaped body is extended from and formed as a single unit with the sleeve.

8. The spindle motor of claim 6, wherein a second connection hole is formed linearly through the sleeve to connect the oil gap of the journal bearings and the oil gap of the thrust bearing.

9. The spindle motor of claim 2, wherein the sleeve includes a first sleeve rotatably supporting the shaft and a second sleeve to which the first sleeve is coupled and fixed and the ring-shaped body is extended from an upper end of the sleeve.

10. The spindle motor of claim 2, wherein the hub includes a first hub having a center hole in which the shaft is coupled and fixed and the inner cylindrical wall body and a second hub having a hole in which the first hub is coupled and fixed and an outer cylindrical wall body to which the magnet is attached.

11. The spindle motor of claim 5, wherein second and third taper seals connected with the first connection hole are formed in the upper portion of the lower journal bearing and in the lower portion of the upper journal bearing, and a fourth taper seal is formed in the upper end portion of the upper journal bearing and contacts the bottom surface of the hub.

12. The spindle motor of claim 2, wherein a magnetic body attracting the hub is attached to the base facing the magnet.

13. The spindle motor of claim 2, wherein an oil groove is formed in an inward spiral shape in the thrust bearing, and oil grooves are formed in a herring bone shape in the journal bearings.
